(19) United States
(12) Patent Application Publication
(10) Pub. No.: US 2016/0288774 A1
(43) Pub. Date: Oct. 6, 2016

(54) WINDSCREEN WIPER DEVICE FOR A VEHICLE

(71) Applicant: ROBERT BOSCH GMBH, Stuttgart (DE)

(72) Inventors: Florian Hauser, Achern (DE); Michael Weiler, Buehl (DE)

(73) Assignee: Robert Bosch GmbH, Stuttgart (DE)

(21) Appl. No.: 15/037,621

(22) PCT Filed: Nov. 3, 2014
(86) PCT No.: PCT/EP2014/073514

§ 371 Date: May 18, 2016

(30) Foreign Application Priority Data
Nov. 18, 2013 (DE) 10 2013 223 440.6

(51) Int. Cl. B60S 1/38

(52) U.S. Cl. CPC B60S 1/3801; B60S 2001/3898

(57) ABSTRACT

The invention relates to a windscreen wiper device (2; 28, 30; 78;) for a vehicle, in particular a motor vehicle. Said windscreen wiper device (2; 28, 30; 78;) comprises an extended upper part (10) which is designed such that it can be at least partially flexible. Said windscreen wiper device also comprises an extended lower part (12) which is designed such that it can be at least partially flexible. Also, a plurality of connection elements (18) for connecting the upper part (10) and the lower part (12) are provided, said connection elements (18) being disposed at a distance from each other along a longitudinal extension (8) of the windscreen wiper device (2; 28, 30; 78) and are (18) secured to the lower part (12) by means of joints (20; 122) and/or can be elastically deformed. A coating (50) is applied to at least one of the elements from the group consisting of: an upper part (10), a lower part (12), a connecting element (18) and a joint (20; 122). The invention also relates to a method for producing said type of windscreen wiper device (2, 28, 30, 78).

### BACKGROUND OF THE INVENTION

The invention relates to a windshield wiper device for a vehicle, in particular a motor vehicle, and furthermore in particular to a wiper blade, and to a method for producing the windshield wiper device.

Windshield wiper devices typically have a wiper arm or wiper lever, wherein a wiper blade is moved on the windshield of a motor vehicle or the like. Here, the wiper blade is moved between an upper reversal point and a lower reversal point. In particular on windshields with intense changes in curvature, the wiper blade easily loses contact with the windshield. This can give rise, in particular in the case of intensely curved windshields, to wiping areas not covered by the wiper blade, and/or to smearing.

Since a wiping process must be optimized with regard to a multiplicity of parameters, such as for example an amount of rain falling on the windshield, a possible snow load on the windshield, the speed of the vehicle and associated wind pressure on the wiper arm, smearing cannot be reliably prevented simply by adapting the pressure of the wiper arm on the windshield. There is therefore a demand for further improving windshield wiper devices.

A main aspect consists in preventing a windshield wiper device from icing up and/or adhering to the windshield, in particular freezing onto the windshield, in the presence of low temperatures. Icing may arise for example in the event of suddenly falling temperatures, in particular also during the operation of the vehicle. This represents a great safety risk.

Icing may be counteracted for example by heating the windshield. This however has disadvantages from an energy aspect, and secondly, the problem of freezing-on is merely displaced: the heat that is generated causes the ice or snow to thaw, water forms, which tends to immediately freeze again in the presence of ambient temperatures below 0 degrees Celsius, and when the heat flow is withdrawn, the risk of freezing-on arises once again, and in particular, the risk of freezing-on becomes greater owing to the water that is generated.

For an improvement of the windshield wiper device, there is a multiplicity of boundary conditions that must additionally be taken into consideration, inter alia with regard to improved functional reliability. Said boundary conditions include the outlay for production or the production costs, the material costs, but also the characteristics of the windshield wiper device, in particular the function under a variety of conditions, and the durability under a multiplicity of conditions. Here, in the case of wiper devices for vehicles, it must be taken into consideration that the cost pressure is ever-increasing, and that the vehicles may be used in a multiplicity of climatic conditions, such that, for example, extreme temperature values arise permanently and/or with great fluctuations.

### SUMMARY OF THE INVENTION

It is the object of the present invention to provide a windshield wiper device by means of which reliable, substantially smear-free wiping of a windshield of a vehicle can be ensured, in particular also at temperatures below freezing.

In one embodiment of the present invention, a windshield wiper device for a vehicle, in particular a motor vehicle, is proposed. The windshield wiper device has an upper part, in particular an elongate upper part, which is at least partially of flexible form. Furthermore, a lower part, in particular an elongate lower part, is provided, which is at least partially of flexible form. Multiple connecting elements for connecting the upper part and the lower part are spaced apart from one another along a longitudinal extent of the windshield wiper device. The connecting elements are fastened to the lower part by way of joints, in particular rotary joints, and/or are elastically deformable. At least one of the elements selected from the group comprising: upper part, lower part, connecting element and joint has a coating.

In a further embodiment of the present invention, a windshield wiper device for a vehicle, in particular a motor vehicle, is proposed. The windshield wiper device has an upper part, in particular an elongate upper part, which is at least partially of flexible form. Furthermore, a lower part, in particular an elongate lower part, is provided, which is at least partially of flexible form. Multiple connecting elements for connecting the upper part and the lower part are spaced apart from one another along a longitudinal extent of the windshield wiper device. The connecting elements are fastened to the lower part by way of joints, in particular rotary joints, and/or are elastically deformable. The windshield wiper device has a coating which is designed to prevent formation of ice on a surface of the windshield wiper device.

In a further embodiment, a method for producing a windshield wiper device, in particular a windshield wiper device according to one of the embodiments described herein, is provided. The method comprises the production of a structure, in particular a rubber structure, which comprises an upper part which is at least partially of flexible form, a lower part which is at least partially of flexible form, and multiple connecting elements, wherein the connecting elements are spaced apart from one another along a longitudinal extent of the windshield wiper device, and wherein the connecting elements are fastened by way of joints to the lower part and/or are elastically deformable, and coating of at least one of the elements selected from the group comprising: upper part, lower part, connecting element and joint with a coating.

Preferred embodiments and particular aspects of the invention will emerge from the dependent claims, from the drawings and from the present description.

The present invention and its embodiments advantageously permit protection of the windshield wiper device against ice, dirt, abrasive particles or intense UV radiation. Intense UV radiation is a problem in particular in the case of certain plastics materials. With regard to the preferably elastic characteristics of the windshield wiper device and associated (preferably usable) plastics materials, UV protection is therefore highly expedient. The coating may for example serve primarily as a coating which reduces formation of ice, and may for this purpose be provided on the individual elements on which ice formation occurs to the greatest extent.

Here, the present invention is also based on the realization that it is advantageous to coat not for example a wiper blade but flexible components of the windshield wiper device. The formation of an ice layer on the windshield wiper device would reduce the elasticity thereof. Specifically in the case of windshield wiper devices with connecting elements which are fastened by way of joints to the lower part and/or upper part and/or are elastically deformable, it is expedient to maintain the elasticity of the individual components or elements. A measure for reducing the formation of ice on surfaces of the windshield wiper device is therefore also to be understood to be a measure for maintaining the mobility or elasticity of the windshield wiper device. In other words: the coating according to the invention ensures that the windshield wiper device delivers a good result (that is to say a clear windshield) even in the presence of low temperatures.

By way of the coating, it is possible to ensure a particularly good adaptation of the windshield wiper device to the curvature of a windshield, even in the presence of low temperatures. This ensures particularly good and precise wiping of the windshield. Non-wiped regions of the windshield, and smearing on the windshield, can be substantially avoided. The structural design of the coated windshield wiper device according to the invention advantageously permits precise adaptation of the windshield wiper device to changes in curvature that arise within the windshield. A substantially uniform contact pressure on the windshield wiper device, in particular on the lower part thereof, is achieved even in the case of intense curvatures and changes in curvature of the windshield. By contrast to conventional windshield wiper devices, it is advantageously not necessary in the case of the coated windshield wiper device according to the invention to perform prior adjustment of the upper part and/or of the lower part to the curvature of the windshield to be wiped, or for the windshield or the windshield wiper device to be warmed up in order to prevent formation of ice. In the case of the windshield wiper device according to the invention, the adaptation to the curvature of the windshield takes place quickly, in uncomplicated fashion and substantially automatically even in the presence of temperatures below freezing. One and the same windshield wiper device can therefore be used for a large number of vehicles substantially independently of the usage location, that is to say for example also for vehicles intended for the Canadian or Scandinavian or Siberian markets.

The coating is advantageously configured such that torsional movements between the connecting elements and the lower part are not impaired or are not noticeably impaired. This ensures a high level of flexibility and adaptability of the lower part even in the presence of a coating. Here, in one embodiment, the connecting elements may likewise be fastened, by way of further joints, to the upper part. This ensures even better adaptability of the windshield wiper device to the windshield to be wiped, wherein in particular, it is possible to achieve a high contact pressure on the windshield, and thus a particularly good cleaning and wiping action. The windshield wiper device is particularly advantageously designed such that torsional movements are likewise possible between the connecting elements and the upper part. The joints are advantageously hinges. The windshield wiper device that is coated according to the invention is in particular designed such that the upper part and lower part are formed in the manner of beams. Furthermore, it is advantageously possible for the upper part and lower part to at least partially be of flexurally elastic form. In one embodiment of the invention, the upper part and lower part are displaceable relative to one another. In a further embodiment, the upper part is arranged opposite the lower part. The connecting elements are fastened to inner sides, which face toward one another, of the upper part and lower part. The connecting elements are particularly advantageously designed to be resistant to buckling.

The connecting elements may be designed to be elastic or elastically deformable, such that a movement of the upper part and of the lower part relative to one another in accordance with the “fin-ray” principle is possible. An elastic design of the connecting elements may render a fastening of the connecting elements to the upper part or lower part by way of joints superfluous.

In one embodiment of the invention, the coating is specially designed to reduce formation of ice on a surface of the windshield wiper device. The coating may specifically be formed as an anti-ice coating. In this way, the functional reliability of the windshield wiper device can be improved. It is duly also possible for the tendency for ice formation to be reduced by way of a coating which is not necessarily in the form of a specific anti-ice coating. An anti-ice coating can however reduce, or virtually eliminate, the formation of ice in a particularly effective manner.

An anti-ice coating is for example particularly expedient if it is provided at least on the lower part, firstly because said lower part is arranged close to a vehicle windshield, which, as a cold material, promotes moisture formation on its surface, and secondly because the lower part also comes into contact, to a great extent, with water that is wiped away by the windshield wiper device.

The coating may for example be formed at least (inter alia) on the joints. In this way, it can be ensured that, in the region in which a particularly intense relative movement takes place or should be able to take place, no ice can form on the surface of the windshield wiper device, or the formation of ice is reduced. A coating applied (inter alia) to the joints ensures in a particularly effective manner that the windshield wiper device remains flexible.

The coating is preferably formed at least on the lower part alone or on the lower part and on the joints, and optionally also on the connecting elements and/or on the upper part. In this way, the probability of the windshield wiper device freezing onto a windshield can be reduced. In the case of a coating also on the connecting elements and/or on the upper part, it is furthermore possible to obtain an improvement with regard to the mobility of the windshield wiper device being maintained even in the presence of particularly low temperatures. Even if ice forms between said individual parts, said ice cannot adhere to the parts and “freeze” the relative position of the parts with respect to one another. Rather, the parts remain movable relative to one another.

In a further embodiment, the coating has, at least in sections, a nanostructured surface. In other words, the coating may be composed of a material which substantially prevents formation of ice, and may additionally have a surface with a nanostructure which also reduces the risk of fouling, and/or which can yet further reduce the risk of icing. In this way, the formation of an ice film, and the adherence of dirt or other foreign bodies, can be substantially prevented, such that the function of the coating is ensured even if the windshield wiper device is used in a very dirty environment or in the presence of particularly low temperatures.

In a further embodiment, the coating has a surface energy of less than 30 mJ/m², preferably less than 25 mJ/m², particularly preferably less than 20 mJ/m².

In a further embodiment, the coating has a coating thickness of 0.02 mm to 1.0 mm, in particular of 0.05 mm to 0.2 mm.

In a further embodiment, the coating is formed at least partially by a foil, in particular a self-adhesive polyurethane foil, applied to the surface of the windshield wiper device. In this way, it is possible in a simple manner for a coating with a predefined coating thickness in a relatively narrow tolerance range to be provided over relatively large planar surfaces. The coating may also exhibit a certain surface characteristic, without the entire windshield wiper device having to be subjected to a process that might impair the material of the windshield wiper device, for example a process for nanostructuring of the surface.

In one variant, the upper part and the lower part are fixedly connected to one another, in particular in an end region of the windshield wiper device, at an outer connecting position. The outer connecting position is formed in front of the connecting elements, in particular as viewed in a direction pointing from the outside inward in the longitudinal extent of the windshield wiper device. This refinement advantageously ensures particularly good stability of the windshield wiper device. Furthermore, it is possible to achieve a particular high level of flexibility and adaptability for the adaptation to the windshield curvature, wherein a uniform contact pressure of the lower part against the windshield is realized. In one advantageous embodiment, the upper part and the lower part may be connected to one another at the outer connecting position such that the upper part and lower part form a wedge. The upper part and lower part are in particular connected to one another at their ends. In further refinements, it is possible for one or more first connecting elements and one or more second connecting elements to be provided as follows. A first connecting element is arranged, in relation to a second connecting element, such that the first connecting element is, relative to the second connecting part, situated in the direction of the connecting position of the upper part and lower part, that is to say is situated in the direction of the tip of the wedge, or at the outside. Here, the first connecting element is shorter than the second connecting element. For example, it is possible for at least 70% or at least 50% of the connecting elements to be designed so as to become shorter toward the outside, that is to say in the direction of the connecting position of the upper part and of the lower part.

In further variants that may be combined with other variants or embodiments, the lower part is, in the unloaded state, of convex form, that is to say with a curvature which projects away from the upper part in a central region. Upon contact with a windshield, proceeding from the convex shape of the lower part, the windshield wiper device as per the embodiments described here can typically assume the corresponding concave shape of the lower part, which adapts to the windshield.

In one variant, the longitudinal axes of the connecting elements lie at angles of between 65° and 115°, in particular between 75° and 105°, with respect to the lower part. This advantageously ensures a particularly good transmission of a force, which acts on the lower part, to the upper part. The angles may typically vary along the longitudinal extent.

In one variant, the spacing between in each case two adjacent connecting elements is less than 50 mm, in particular less than 30 mm. In this way, a particularly high level of flexibility of the windshield wiper device, in particular of its lower part, and good adaptation to the curvature and changes in curvature of the windshield to be wiped, are ensured.

In a further advantageous variant, a flexible windshield wiper lip is attached to a side, which is averted from the upper part, of the lower part. In this way, a particularly high level of functionality of the windshield wiper device is advantageously realized.

In a further variant, there is formed between the upper part and the lower part an intermediate space in which there is arranged a spoiler for influencing an air flow that enters the intermediate space. In this way, the precise wiping of the windshield can advantageously be further improved. For example, the spoiler may be designed such that, even at high travelling speeds of the vehicle, compensation of a wind lift force, which otherwise reduces the contact pressure of the windshield wiper device against the windshield, is realized. The spoiler may furthermore be designed such that a wind lift action is utilized to push the windshield wiper device downward in the direction of the windshield. The contact pressure of the windshield wiper device is increased, and the particularly precise abutment thereof against the curvature of the windshield is ensured.

In a further variant, at least one part, which is of flexible form, of the lower part is formed by way of a material which has a modulus of elasticity which lies in a range between 0.005 kN/mm2 and 0.5 kN/mm2, in particular 0.01 kN/mm2 and 0.1 kN/mm2. In this way, a particularly bendable and flexible lower part can be realized.

In a further variant, the coated windshield wiper device according to the invention is designed so as to be constructed in accordance with a so-called fin-ray principle. Said fin-ray principle is derived from the structure of fins of certain fish species. In accordance with the fin-ray principle, in the event of a pressure force acting on the lower part of the windshield wiper device, the lower part and advantageously also the upper part of said windshield wiper device do not deflect in the direction of the pressure force but arch in the opposite direction, that is to say in the direction from which the pressure force originates.

In further embodiments, the upper part and the lower part are connected to the connecting elements by way of joints or further joints. The joints on the upper part and lower part permit a movement in accordance with the fin-ray principle, and thus serve for the particularly good adaptation of the windshield wiper device or of a wiper lip to the windshield.

In one variant, the joints and/or the further joints to the upper part may comprise a first joint part and a second joint part. For example, the first joint part may be cylindrical or spherical, and the second joint part may comprise an undercut for receiving the first joint part. The two-part design of the joints offers a multiplicity of possibilities for favorably influencing joint characteristics such as the creep behavior. Materials may be selected in order to permit reliable and durable joint characteristics even in the presence of intense temperature fluctuations and/or in the presence of permanently high ambient temperatures.

In a further embodiment, the joints may be in the form of film hinges. For example, the film hinges may be formed in one piece with the connecting element and/or the lower part. In particular, the connecting element, the upper part and the lower part, and the joints, may be of unipartite form. The embodiment of the joints as film hinges permits simple and inexpensive production. With the corresponding design, it is possible for the wiper blades or the wiper blade devices to be provided entirely, or over large regions, in ready-from-the-mold form.

Here, a film hinge is preferably to be understood to mean a joint which is formed in one piece and in the case of which mobility (in particular at least one degree of freedom) is provided through the provision of a local narrowing of the material thickness or wall thickness. The mobility of the joint may then be set by way of the elasticity of the material used and/or the material thickness or wall thickness.

In one variant, the film hinges may have a thickness of 0.1 mm to 0.8 mm, in particular 0.2 to 0.4 mm. The thickness of the film hinges allows for a flexural stiffness of a predetermined value or below, and furthermore permits production in an injection-molding process with corresponding characteristics of the wiper blade, for example adequate creep resistance of the joints.

In a further embodiment, the film hinges may be composed of a material from the group comprising: POM, PA and TPE. The material selection of the film hinges, in particular in conjunction with the thickness of the hinges, allows for a flexural stiffness of a predetermined value or below, and furthermore permits production in an injection-molding process with corresponding characteristics of the wiper blade, for example adequate creep resistance of the joints.

In one variant, the first and the second joint part may be clipped to one another, or the first and the second joint part may be produced by way of a 2-component injection-molding process. Clipped joints offer a multiplicity of possibilities for favorably influencing the joint characteristics, for example the flexural stiffness and/or the creep behavior. Materials may be selected in order to permit reliable and durable joint characteristics even in the presence of intense temperature fluctuations and/or in the presence of permanently high ambient temperatures. Furthermore, it is possible to provide reliable wiping devices even for relatively complex fields of application. 2-component injection-molding processes likewise make it possible to provide joint variants for relatively complex fields of application. The advantage of production by way of a workpiece in ready-from-the-mold form with two-part joints is however opposed by the restrictions in the selection of the materials for the production of a spherical or cylindrical joint produced by 2-component injection molding.

In one variant, the windshield wiper device may furthermore comprise a wiper lip provided on the lower part, wherein the wiper lip and the joint are provided so as to at least partially comprise the same material. It is thus possible to use relatively high-grade materials for the joint and the wiper lip, which both exhibit increased demands on material selection (elasticity, flexural stiffness, creep resistance). Since other parts of the wiper device are also provided having other materials, the production costs are nevertheless limited. Furthermore, the windshield wiper device may be produced in a 2-component method.

In one variant, the connecting elements are elastically deformable and have a modulus of elasticity of 3000 MPa or lower, in particular of 2 MPa to 2000 MPa, in particular 10 MPa to 500 MPa. In this way, it is possible to provide a windshield wiper device with good elasticity, even if the latter is coated.

In a further embodiment, the upper part, the lower part and the connecting elements are formed in one piece. The upper part, the lower part and the connecting elements may be formed in one piece by way of a rubber structure with openings. In this way, it is possible to prevent relative movements from occurring between individual parts, in particular joint parts. Such interfaces with relative movements have the disadvantage that the interface can freeze up at very low temperatures, and can often be freed from ice again only with relatively great effort. In the case of a one-piece form, it is possible for a coating to advantageously be provided over the entire windshield wiper device. The rubber structure may be produced for example from a material selected from the group comprising EPDM or TPE.

In one embodiment of the method according to the invention, the coating of the structure is performed by way of plasma treatment and/or involves the adhesive bonding of a foil to the surface of the structure. In other words, the coating may also be understood to mean the application, in particular by adhesive bonding, of a foil. Both coating variants may be used, for example in a manner dependent on how easily accessible the individual parts or regions of the windshield wiper device are. The joints are preferably coated by way of plasma treatment, in particular because the joints typically do not have relatively large planar surfaces and are relatively poorly accessible, and because the joints exhibit intense relative movements. It has been found that a plasma coating can withstand such movements particularly effectively, without detaching from the surface. Regions in which only little movement or relative movement takes place are also well suited to coating by way of a foil.

In one embodiment of the method, the production of the structure encompasses injection-molding of the rubber structure. In this way, the entire structure can be provided in a relatively simple manner.

### BRIEF DESCRIPTION OF THE DRAWINGS

Exemplary embodiments of the invention are illustrated in the figures and will be described in more detail below. In the figures:

FIG. 1A is a schematic illustration of an exemplary embodiment of a coated windshield wiper device according to the invention in the form of a wiper blade, and also, in each case in a detail view, an individual connecting element of the wiper blade in non-coated form (detail view shown on the left) and in coated form according to the invention (detail view shown on the right),

FIG. 1B shows a schematic detail view of an exemplary embodiment of a coated windshield wiper device according to the invention in the form of a wiper blade, which is coated only on a lower part,

FIG. 2A is a schematic illustration of an exemplary embodiment of a windshield wiper device on which a coating can be provided according to the invention, specifically in the form of a wiper blade, in a basic position,

FIG. 2B is a schematic illustration of the wiper blade as per FIG. 2A in a position placed against a windshield,

FIG. 3A is a schematic illustration of a further exemplary embodiment of a windshield wiper device on which a coating can be provided according to the invention, specifically in the form of a wiper arm with integrated wiper blade, in a basic position,

FIG. 3B is a schematic illustration of the wiper arm with integrated wiper blade as per FIG. 3A in a position placed against a windshield,

FIG. 4A is a schematic illustration of a detail of the wiper blade as per FIG. 3A,

FIG. 4B is a schematic illustration of a detail of the wiper blade as per FIG. 3B,

FIG. 5A is a schematic illustration of a further exemplary embodiment of a windshield wiper device on which a coating can be provided according to the invention, specifically with an integrated spoiler,

FIG. 5B is a schematic illustration of a cross section through the windshield wiper device as per FIG. 5A,

FIG. 6 shows a detail of a schematic illustration of an exemplary embodiment of a windshield wiper device according to the invention in the form of a wiper blade, on which a coating is provided,

FIG. 7 is a schematic illustration of a joint as per exemplary embodiments of a windshield wiper device according to the invention in the form of a wiper blade, on which a coating is provided, wherein a film hinge is used as a joint,

FIGS. 8A and 8B are schematic illustrations of a joint as per exemplary embodiments of a windshield wiper device according to the invention in the form of a wiper blade, on which a coating is or can be provided, wherein a first joint part and a second joint part are used for forming the joint,

FIG. 9 is a schematic illustration of a joint as per exemplary embodiments of a windshield wiper device according to the invention in the form of a wiper blade, on which a coating is provided, wherein a first joint part and a second joint part are used for forming the joint, said joint parts being produced in a 2-component injection-molding process, and

FIG. 10 shows a flow diagram illustrating embodiments of the production of windshield wiper devices according to the invention.

### DETAILED DESCRIPTION

Below, unless stated otherwise, the same reference designations are used for identical elements and elements of identical action.

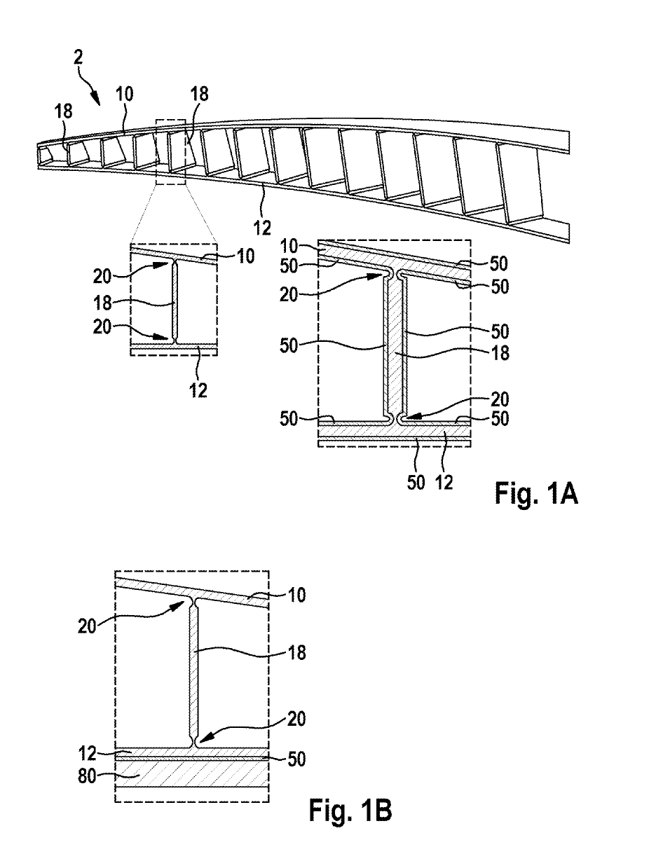

FIG. 1A is a schematic illustration of an exemplary embodiment of a windshield wiper device according to the invention. The windshield wiper device is, in this exemplary embodiment, a wiper blade 2. The wiper blade 2 is normally attached to a wiper blade arm which, for the wiping action, is driven by way of a motor. The wiper blade 2 has an elongate upper part 10 and a likewise elongate lower part 12.

Both the upper part 10 and the lower part 12 are to be understood, in terms of their function, as flexible beams, or may be designed as flexible beams, which are for example in each case of unipartite form in FIG. 1A. This makes it possible to realize a particularly stable construction. The upper part 10 and the lower part 12 are arranged so as to be situated opposite one another. The upper part 10 and the lower part 12 are connected to one another by way of connecting elements 18. The connecting elements 18 are fastened to inner longitudinal sides, which face toward one another, of the upper part 10 and of the lower part 12 by way of joints 20. Here, the joints 20 are in each case formed as a type of hinge. In particular, the joints 20 may be in the form of film hinges. This is advantageous in particular if the upper part 10, lower part 12 and/or connecting elements 18 are produced from a plastics material or are lined with a suitable plastics material.

The connecting elements 18 are spaced apart from one another along the longitudinal extent of the wiper blade 2. The spacings between in each case two adjacent connecting elements 18 are at least approximately equal. Said spacings may however also be selected so as to differ. The spacings between the upper part 10 and the lower part 12 are determined primarily by the lengths of the connecting elements 18. The connecting elements 18 may, if joints are used, be designed to be resistant to buckling.

The wiper blade 2 has a coating 50. The coating 50 is preferably designed to reduce icing of the wiper blade 20. The coating 50 may be specially designed as an anti-ice coating. The coating 50 is preferably a nanostructured coating. The surface energy of the coating 50 is preferably less than 30 mJ/m², in particular less than 20 mJ/m².

The coating 50 may for example be a coating applied by plasma treatment. The coating 50 may also be provided in the form of an adhesively bonded foil, for example in the form of a self-adhesive polyurethane foil, which has preferably been subjected to plasma treatment. The coating 50 may also be formed partially by a coating applied by plasma treatment, and partially by a foil. The foil is preferably provided at least on the substantially planar surfaces of the wiper blade 2, that is to say for example on the top side of the upper part 20 and/or on the bottom side of the lower part 12, or also on the side surfaces of the connecting elements 18.

The coating 50 preferably extends over the entire wiper blade 2, that is to say over both the upper part 10 and the lower part 12 and the connecting elements 18 and the joints 20. In other words, it is preferable for the coating 50 to be applied to all of the surfaces of the wiper blade 2.

The joints 20 are not blocked by the coating 50. Rather, the coating 50 ensures the mobility in particular of joints 20 in the form of film hinges. Here, the joints 20 or film hinges can be kept movable even in winter in the presence of low temperatures and the risk of icing.

The wiper blade 2 may for example be a wiper blade which is designed for wiping a rear windshield. The wiper blade 2 may likewise also be provided for a front windshield. However, the use for a rear windshield appears to be preferable, in particular because a rear windshield wiper is used more seldomly, and thus exhibits a greater tendency to freeze on.

FIG. 1B shows, in a detail view, a wiper blade 2 which is coated only on the lower part 12. The coating 50 may optionally be in the form of a directly applied coating or in the form of a foil. A foil can be applied to the underside 12 in a relatively simple manner, because the underside 12 is of substantially planar form and is easily accessible, at least before a wiper lip 80 is mounted on the underside 12.

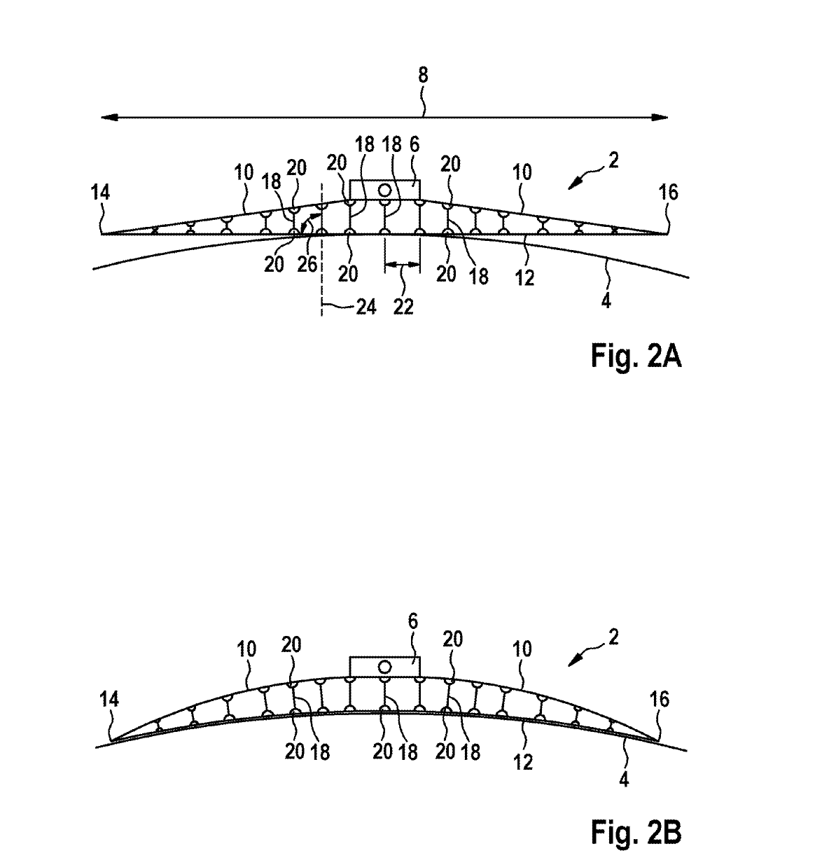

FIG. 2A is a schematic illustration of an exemplary embodiment of a windshield wiper device. In this exemplary embodiment, the windshield wiper device is a wiper blade 2. The wiper blade 2 serves for wiping a windshield 4 of a vehicle, which is for example a motor vehicle, in particular an automobile. Normally, the wiper blade 2 is attached to a windshield wiper arm which, for the wiping action, is driven by way of a motor. For this purpose, the wiper blade 2 has a bracket 6 by which it can be fastened to the windshield wiper arm. The wiper blade 2 is, in FIG. 2A, situated in a basic position in which it is at least partially raised from the windshield 4. The wiper blade 2 has a longitudinal extent 8 and has an elongate upper part 10 and a likewise elongate lower part 12. The longitudinal extents of the upper part 10 and of the lower part 12 correspond substantially to the longitudinal extent 8 of the wiper blade 2.

Both the upper part 10 and the lower part 12 are, or may be designed as, flexible beams which, in FIG. 2A, are for example in each case of unipartite form. This makes it possible to realize a particularly stable construction. It is likewise possible for only in each case one part of the upper part 10 and/or of the lower part 12 to be designed to be flexible. Furthermore, it is alternatively possible for the upper part 10 to be formed in two parts, wherein then, in each case one end of the two parts of the two-part upper part 10 is fastened to the bracket 6. In some embodiments that may be combined with the other embodiments described here, for the upper part 10 and/or the lower part 12, a material is used which has a modulus of elasticity which lies in a range between 0.005 kN/mm2 and 0.5 kN/mm2, in particular 0.01 kN/mm2 and 0.1 kN/mm2. This makes it possible to realize suitable flexibility of the upper part 10 and of the lower part 12. Together with a suitably designed cross-sectional area of the upper part 10 and of the lower part 12, optimum flexural stiffness is thus realized. The upper part 10 and the lower part 12 are arranged so as to be situated opposite one another. Both ends of the upper part 10 are fixedly connected, at outer connecting positions 14 and 16, to in each case one end of the lower part 12. Otherwise, the upper part 10 and the lower part 12 are spaced apart from one another.

The connecting elements 18 are fastened, at inner longitudinal sides, which face toward one another, of the upper part 10 and of the lower part 12 by way of joints, in particular rotary joints 20. The joints 20 are in this case hinges. In particular, the joints 20 may be in the form of film hinges. This is advantageous in particular if the upper part 10, lower part 12 and/or connecting elements 18 are produced from a plastics material or coated with a suitable plastics material.

In typical embodiments described here, which may be combined with other embodiments described here, a joint is selected from the group comprising: a hinge, a film hinge, a narrowing of the material in order to realize relatively low stiffness along a torsional axis, a joint with an axis of rotation, a means for connecting the upper part to the connecting element or for connecting the lower part to the connecting element, which means permits the displacement of the lower part relative to the upper part along the longitudinal extent, etc.

The connecting elements 18 are spaced apart from one another along the longitudinal extent of the wiper blade 2. The spacings are advantageously less than 50 mm, in particular less than 30 mm. In the present exemplary embodiment, one spacing 22 is illustrated as a representative of the spacings between in each case two connecting elements 18. The connecting elements 18 are, in particular in the basic position of the wiper blade 2, fastened to the lower part 12 such that their longitudinal axes run at angles 26 of between 55° and 125°, with the angles lying in particular between 75° and 105°, with respect to the lower part 12. The angle particularly advantageously varies along the longitudinal extent 8. A corresponding situation applies in the present exemplary embodiment for the fastenings of the connecting elements 18 to the upper part 10. In FIG. 2A, one longitudinal axis 24 is illustrated as an example of the longitudinal axes of the connecting elements 18, and one angle 26 is illustrated as an example of the angles between the connecting elements 18 and the lower part 12. The spacings between the upper part 10 and the lower part 12 are defined primarily by the lengths of the connecting elements 18. The lengths of the connecting elements 18, and the spacings between upper part and lower part, increase in size proceeding from the two outer connecting positions 14, 16 as far as approximately the locations at which the bracket 6 that is attached to the upper part 10 begins. In this way, in the side view of the wiper blade 2 as per FIG. 2A, the upper part 10 and lower part 12 form a double wedge, wherein the tips of the two wedges point in opposite directions. The connecting elements may be designed to be resistant to buckling.

In the case of the wiper blade 2 shown in FIG. 2A, a coating (not illustrated) may be applied to at least one of the elements selected from the group comprising: upper part 10, lower part 12, connecting elements 18 and joints 20.

FIG. 2B is a schematic illustration of the wiper blade 2 as per FIG. 2A in a position placed against the windshield 4. Since the windshield 4 has a curvature, it is the case that, when the wiper blade 2 bears against the windshield 4, contact pressure forces act on the lower part 12. Since the upper part 10 and the lower part 12 are flexible beams and the connecting elements 18 are mounted rotatably on the upper part 10 and lower part 12, the upper part 10 and the lower part 12 are displaceable relative to one another. Owing to the pressure forces that act on the lower part 12 from below, the wiper blade 2 bends in the direction from which the pressure forces originate, and bears exactly against the curvature of the windshield 4.

Owing to the construction of the embodiments described here, it is the case that, when a force is exerted on the lower part (by the windshield 4), the lower part bends in the direction from which the force acts. This is realized by way of the connection of the upper part 10 and of the lower part at connecting positions 14 and/or 16, the shape, and by way of rotary joints at the connection between the connecting elements and the upper part and lower part.

In the illustration as per FIG. 2B, there is a small spacing between the wiper blade 2 and the windshield 4, which spacing serves here merely for the illustration of the windshield 4 and of the wiper blade 2 and, in reality, substantially does not exist when the wiper blade 2 bears against the windshield 4. Furthermore, in the case of most wiper blades, a rubber lip is situated on the lower side, averted from the upper part 10, of the lower part 12, which rubber lip (not illustrated for the sake of clarity) is set down on the windshield 4 for wiping purposes.

A windshield wiper device of this kind, for example a windshield wiper arm or a windshield wiper arm with windshield wiper blade, has the advantage of improved adaptation to a windshield of a motor vehicle. In the case of a conventional windshield wiper blade, the upper part thereof is conventionally rigid, that is to say is not designed to be flexible.

A windshield wiper device as per embodiments described here utilizes the effect of tailfins of certain fish species, which, under the action of lateral pressure, do not deflect in the direction of the pressure but curve in the opposite direction, that is to say in the direction from which the pressure originates. This principle is also referred to as the “fin-ray” principle.

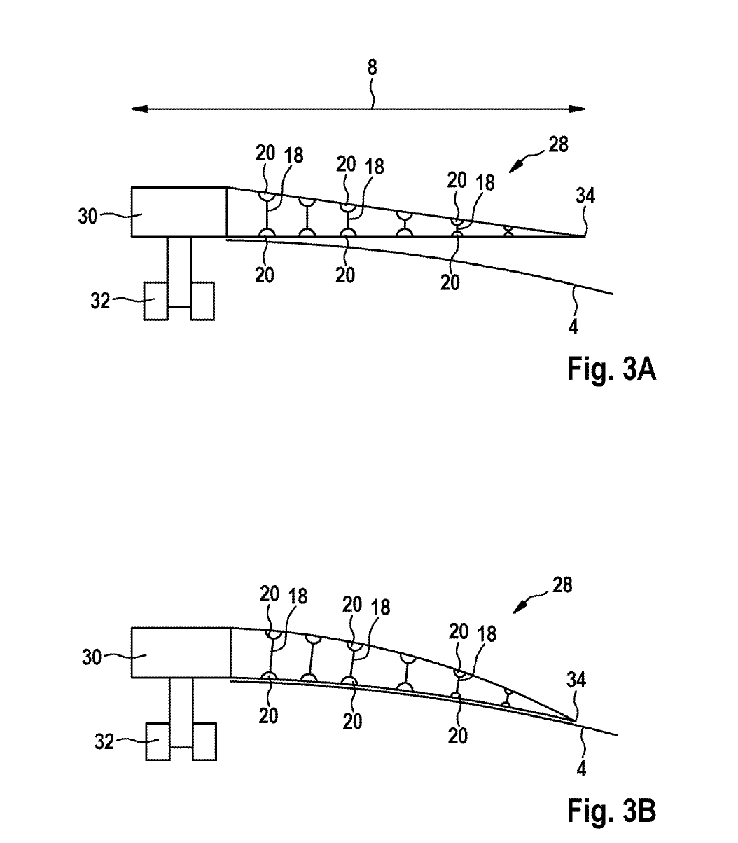

FIGS. 2A and 2B show a wiper blade 2 with a longitudinal extent 8 extending substantially between the connecting positions 14 and 16. Such an arrangement is commonly used for front windshield wipers. Alternatively, however, a windshield wiper device may also have only one connecting position which, in analogy to FIGS. 2A and 2B, corresponds to a halving of the windshield wiper device, and wherein, for example, a rotary spindle is provided at a position of the bracket 6. Such an arrangement is commonly used for rear windshield wipers. This is illustrated by way of example inter alia in FIGS. 3A and 3B. Optional refinements and details such as are described in individual embodiments may be used generally for both variants of an arrangement of a windshield wiper device.

FIG. 3A is a schematic illustration of a further exemplary embodiment of the windshield wiper device in the basic position. Here, the windshield wiper device is a wiper arm with an integrated wiper blade 28 which is attached to a fastening part 30. The fastening part 30 is connected to a wiper motor 32 which drives the fastening part 30 in order to wipe the windshield 4. The wiper blade 28 is of wedge-shaped design, wherein one end of the upper part 10 is fixedly connected at an outer connecting position 34 to one end of the lower part 12. The respective other ends of the upper part 10 and of the lower part 12 are fastened to the fastening part 30. With regard to the basic construction and in particular the fastenings of the connecting elements 18, the windshield wiper device as per FIG. 3A corresponds in principle to that as per FIG. 2A.

In the case of the windshield wiper device shown in FIG. 3A, a coating (not illustrated) may be applied to at least one of the elements selected from the group comprising: upper part 10, lower part 12, connecting elements 18 and joints 20.

FIG. 3B is a schematic illustration of the wiper blade 28 with integrated wiper arm 30 as per FIG. 3A in a position placed against the windshield 4. In this case, too, pressure forces act on the lower part 12 of the wiper blade 28 from below from the direction of the windshield 4, such that the lower part 12 and the upper part 10 bend in the direction of the windshield 4.

Both in FIG. 2A and in FIG. 3A, the wiper blade is illustrated in its position in which it has not been placed against the windshield, such that the lower part 12 is of substantially straight form. According to yet further embodiments that may be combined with other embodiments, the lower part is, in the unloaded state, of convex form, that is to say with a curvature which projects away from the upper part in a central region. In yet further embodiments that may be combined with other embodiments, the lower part is, in the unloaded state, of convex form in at least one region and of concave form in at least one other region. Upon coming into contact with a windshield, the windshield wiper device as per the embodiments described here can typically then, proceeding from the convex shape of the lower part, assume the corresponding concave shape, which adapts to the windshield, of the lower part.

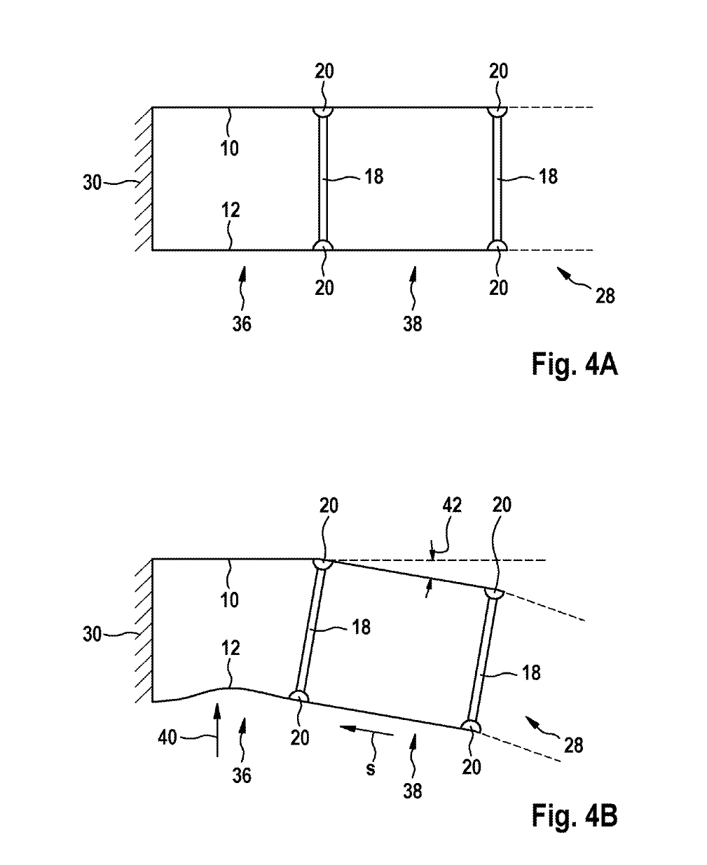

FIG. 4A is a schematic illustration of a detail of the wiper blade 28 as per the exemplary embodiment in FIG. 3A, in which the wiper blade 28 is situated in the basic position. The illustration shows the left-hand end region of the wiper blade 28, in which one end of the upper part 10 and one end of the lower part 12 are fastened to the fastening part 30. Proceeding from the transition from the fastening part 30 to the wiper blade 28, FIG. 4A shows the first two connecting elements 18, which delimit two wiper blade elements 36 and 38. The connecting elements 18 are fastened by way of joints 20 to the upper part 10 and to the lower part 12.

FIG. 4B is a schematic illustration of a detail of the wiper blade 28 as per the exemplary embodiment as per FIG. 3B, in which the wiper blade 28 is placed against the windshield 4. Pressure forces act on the lower part 12 from below from the direction of the windshield. In FIG. 4B, one pressure force 40 is illustrated as a representative of the pressure forces. The pressure force 40 causes an arching and bending of the lower part 12 of the wiper blade element 36. As a result, the joint 20 of the first connecting element 18 is displaced to the left by a distance s. The second wiper blade element 38 bends downward in the direction from which the pressure force 40 originates, and bears closely against the windshield. Here, an angle 42 forms between the first wiper blade element 36 and the second wiper blade element 38. Furthermore, a further pressure force is generated which then acts on the lower part 12 of the second wiper blade element 38 and which prevents further downward bending of the second wiper blade element 38. A chain reaction to the wiper blade element situated adjacently to the right occurs as far as the end of the wiper blade 28.

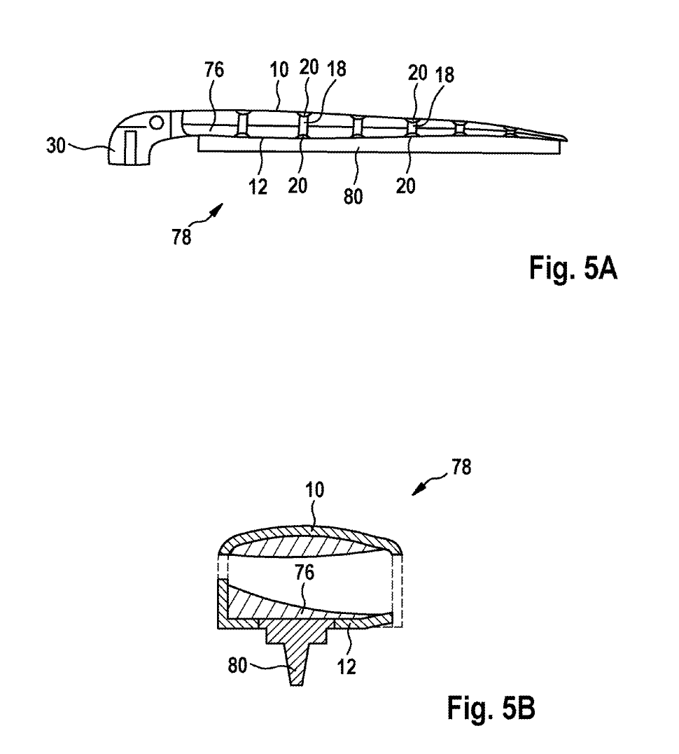

FIG. 5A is a schematic illustration of an exemplary embodiment of a windshield wiper device having an integrated spoiler 76. The windshield wiper device has a wiper blade 78, to the lower part 12 of which a rubber lip 80 is attached for the purposes of wiping the windshield. The spoiler 76 is integrated into an intermediate space which is formed between the upper part 10 and the lower part 12. The spoiler 76 serves for influencing an air flow that enters the intermediate space. The spoiler 76 is realized in the form of an oblique surface formed on the lower part 12 of the wiper blade 78. The spoiler 76 may for example be produced from rubber which is injection-molded around a suitable wiper blade structure, composed for example of sheet metal.

In the case of the windshield wiper device shown in FIG. 5A, a coating (not illustrated) may be applied to at least one of the elements selected from the group comprising: upper part 10, lower part 12, connecting elements 18 and joints 20.

FIG. 5B is a schematic illustration of a cross section through the wiper blade 78 as per FIG. 5A.

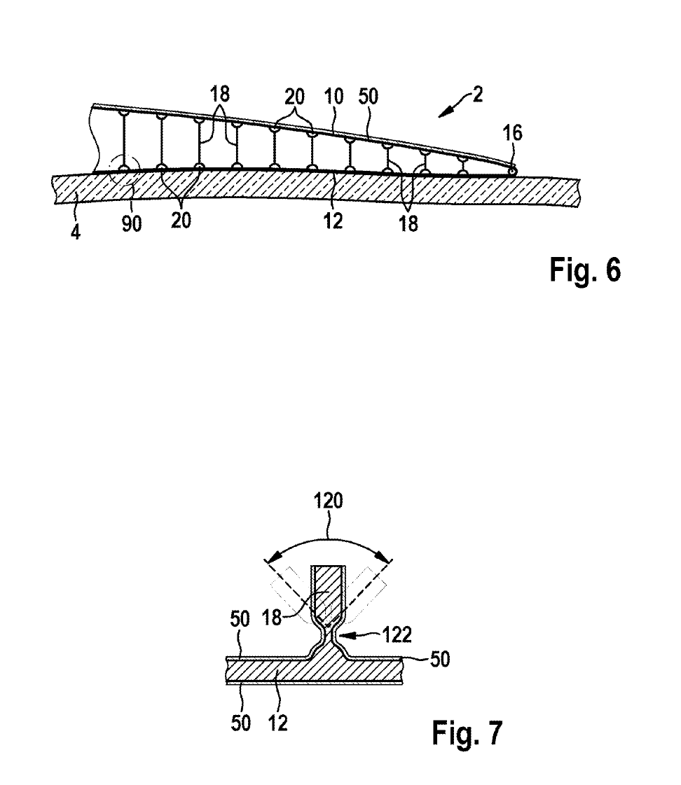

FIG. 6 shows a detail of a schematic illustration of a wiper blade 2 of a windshield wiper device. The wiper blade 2 serves for wiping a windshield 4 of a vehicle, for example of a motor vehicle, in particular of a passenger motor vehicle. In embodiments of the present invention, the wiper blade 2 is a fin-ray wiper.

On an upper part 10 and on a lower part 12 there are arranged connecting elements 18 which are connected by way of joints 20 to the upper part and to the lower part. In typical embodiments of the present invention, there exists a group of joints which are advantageously suitable for use in the case of fin-ray wipers, in particular in motor vehicles.

In further typical embodiments, a wiper lip may be provided on the lower part 12 of the wiper blade 2 illustrated in FIG. 6. The wiper lip wipes across the windshield of the vehicle in order to clean said windshield. In the case of ready-from-the-mold wiper blades, such as are described for example with reference to FIG. 6, said wiper lip may, in a preferred embodiment, be provided in integral form.

For example, the lip may be composed of the same material as the wiper blade. The lip may be composed of a different material, with a 2-component injection-molding process being used, or the lip may be provided by explosive methods. Alternatively, on the lower part of the wiper blade 12, there may be provided a receptacle such that the wiper lip can be threaded in. This offers the advantage that, for the exchange of the wiper blade, it is merely necessary for the wiper lip to be exchanged, thus permitting a material saving.

A coating 50 has been applied to the windshield wiper device shown in FIG. 6, specifically to the upper part 10. The coating 50 may be a layer applied by way of plasma treatment, and/or may be at least partially provided by a foil. The coating may also be applied to at least one of the further elements selected from the group comprising: lower part 12, connecting elements 18 and joints 20.

The following figures illustrate different variants of said joints. In particular, FIGS. 7 to 9 illustrate a detail 90 indicated in FIG. 6. The joints are, in typical embodiments, designed such that one degree of freedom exists. That is to say, the joints are typically hinges.

FIG. 7 shows a particularly preferred embodiment of a joint 20. A film hinge 122 is provided between the lower part 12 and the connecting element 18. In this way, it is possible to realize a movement with one degree of freedom, as indicated by the angle 120.

The joint 20 is coated, for example in its entirety, with a coating 50. The coating 50 covers the entire joint 20. The coating 50 is provided both on the lower part 12 and on the (respective) connecting element 18. The coating 50 runs in continuous fashion, that is to say without interruption, from the connecting element 18 to the top side of the lower part 12. A coherent coating 50 covers both at least one side of the (respective) connecting element 18 and the top side of the lower part 12. In this way, particularly effective protection against formation of ice, or generally against stiffening (decrease of mobility or elasticity) can be ensured in a region of the windshield wiper device which is highly exposed to moisture and dirt.

The coating 50 may in this case optionally be formed by a layer applied directly to the surface of the windshield wiper device and/or by a foil.

In typical embodiments that may be combined with other embodiments, the wiper blade may be formed integrally with the components lower part 12, upper part 10, connecting elements 18, and with a multiplicity of hinges and joints 20. For example, all of the joints 20 may be formed integrally with the lower part 12 and with the upper part 10. This may be performed for example by way of an injection-molding process.

Embodiments in which the joint is provided by a film hinge thus provide a very simple way of providing the joints for a fin-ray wiper. The wiper blade 2 may be provided in unipartite, in particular ready-from-the-mold form. In typical embodiments, the film hinges exhibit high extensibility. This may be achieved for example by way of a material selected from the group PP, PE, POM and PA.

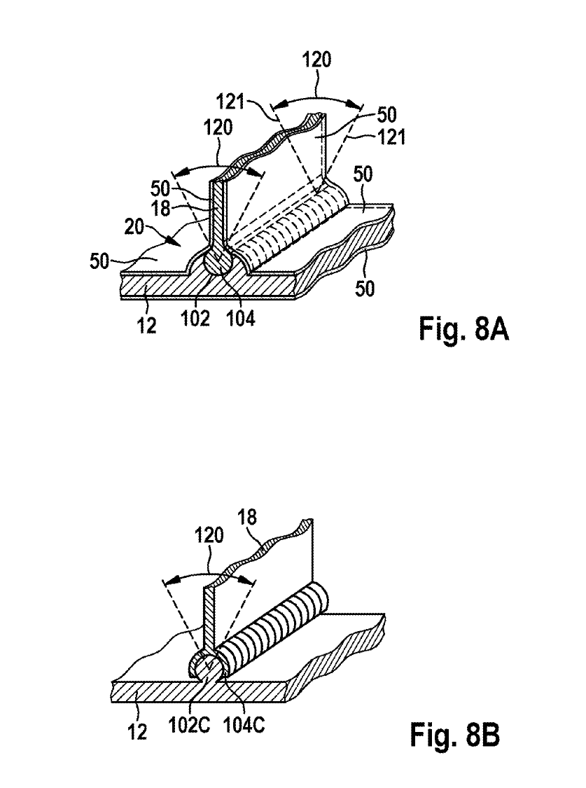

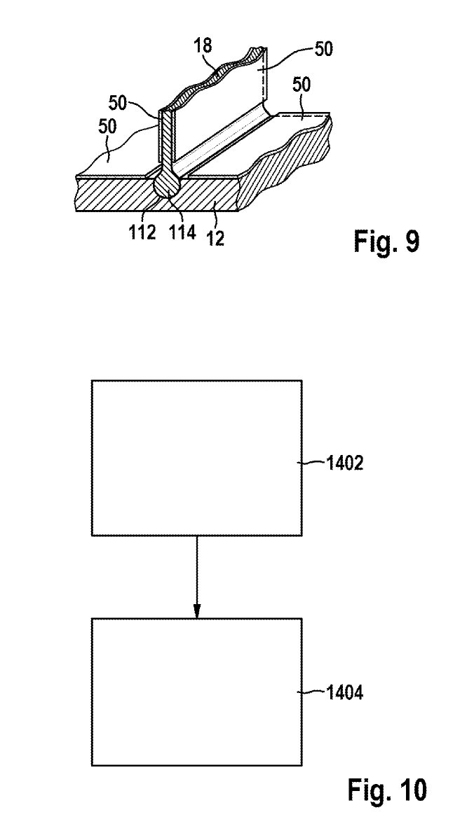

Embodiments of the present invention may, in the joint or hinge, exhibit a flexural stiffness of 75 Nmm/rad or less, for example of 15 to 35 Nmm/rad. In the case of the joints of two-part form (see for example FIGS. 8A to 9), this may be realized in a particularly inexpensive manner. For the embodiments described in conjunction with FIG. 7, that is to say for film hinges, a suitable material selection may be provided in combination with suitable shaping. Here, it must be taken into consideration that a particularly thin film hinge can, owing to the creep characteristics of the material, lead to permanent deformation, which impairs the function of the film hinge. For example, in the case of very high temperatures acting over a certain period of time, the material can “flow away”, such that the function of the hinge is permanently changed or impaired. Furthermore, the film hinge should exhibit flexural stiffness in a certain value range. Finally, the dimensions of the material must be configured such that a production method, such as for example an injection-molding method, can be used inexpensively. For example, very thin regions, or regions of a workpiece arranged behind a very thin region, cannot be adequately filled in an injection-molding process. The dimensions of the workpiece are also limited by this.

In embodiments that may be combined with other embodiments, the material from which a wiper blade with upper part, lower part and film hinge is provided may have a modulus of elasticity of 300 to 1600 MPa. A modulus of elasticity of 1000 MPa or a lower is preferable. In the case of lower moduli of elasticity, however, it must be taken into consideration that good creep characteristics, that is to say a low level of creep of the material, is ensured.

In further typical embodiments that may be combined with other embodiments, a film hinge, in particular a film hinge formed integrally with the connecting element 18, may be provided such that the width of the connecting element 18 outside the hinge region is from 1 mm to 3 mm, for example is 1.5 mm, and the width in the region of the film hinge is from 0.1 mm to 0.8 mm, for example is 0.3 mm.

FIG. 8A shows a further joint variant as per embodiments of the present invention. A joint as per the detail 90 indicated in FIG. 6 is illustrated. The other joints on the lower part 12 or on the upper part 10 of the wiper blade 2 may be of analogous design. FIG. 8A shows the lower part 12 with a joint part 102 which is provided in cylindrical form or as a hollow cylinder equipped with an undercut. The connecting element 18 is formed with a corresponding joint part 104. The corresponding joint part 104 is a cylinder provided on the connecting element 18 or a cylinder formed in one piece with the connecting element 18. The joint part 102, that is to say the hollow cylinder with undercut, may also be formed in one piece with the lower part 12 of the wiper blade 2.

The joint 20 thus leads to mobility of the connecting element 18 in the region of the angle 120. This is likewise illustrated by the auxiliary line 121. In typical embodiments, the connecting element 18 may extend along the axis of rotation of the cylinder 104. The joint 20 has a first joint part 102 and a second joint part 104.

A coating 50 is provided on the joint 20. The coating 50 is provided in this case firstly on the lower part 12, specifically both on the top side and on the bottom side of the lower part 12, and secondly also on the connecting element 18. The coating 50 may in this case also be provided on the second joint part or cylinder 104, and likewise, the coating 50 may also be provided on the surface of the hollow cylinder with undercut or of the first joint part 102. In other words, it is also possible for the friction surfaces or contact surfaces of the two joint parts 102, 104 to be coated. This reduces the risk of the extremely small moisture molecules also collecting in a small gap between the two joint parts 102, 104 and causing the joint 20 to become frozen or blocked. In this way, it is possible to prevent a situation in which the joint 20 freezes up at the interface 102, 104 such that it can no longer be freed from ice without the entire windshield wiper device having to be heated to above the freezing point. The coating 50 is preferably a coating applied by way of plasma treatment, at least in the region of the joint parts 102, 104. Planar surfaces may optionally also be coated by way of a foil.

FIG. 8B shows a variant of a joint as per embodiments of the invention, wherein FIG. 8B is of similar design to FIG. 8A. By contrast to FIG. 8A, the embodiment illustrated in FIG. 8B has a joint part 102C, which is in the form of a cylinder, and a joint part 104C, which is in the form of a hollow cylinder with undercut. As already discussed, the joint part 102C may be formed integrally with the lower part 12 of the wiper arm 2, or may be attached to the lower part 12. Analogously, the joint part 104C, that is to say the hollow cylinder with undercut, may be formed integrally with the connecting element 18 or may be attached thereto.

A coating (not illustrated) may be provided on the joint 20, analogously to the exemplary embodiment shown in FIG. 8A. The coating may for example be provided on the lower part 12 and/or on the connecting element 18. The coating may also be provided on the joint part 104C (optionally on the outer shell surface and/or on the inner shell surface) and/or on the joint part 102C. By way of a coating, it is possible here in particular for the advantages described in conjunction with FIG. 8A to be realized.

In FIGS. 8A and 8B, the connecting elements 18 may be clipped onto the lower part 12. The clipping may be performed both in the case of finished individual parts or, when the workpieces are still in the warm state, within a tool for producing the workpieces.

FIG. 9 shows a further embodiment illustrating a joint with a first joint part 112 and a second joint part 114. FIG. 9 illustrates the joint parts as cylindrical joint parts, such as are illustrated for example also in FIG. 8A or FIG. 8B.

Here, the coating 50 is provided firstly on the lower part 12, specifically on the top side of the lower part 12, and secondly also on the connecting element 18. Friction surfaces or contact surfaces of the two joint parts 112, 114 are not coated. In other words, the coating 50 is provided adjacently, as far as a region in which the two joint parts 112, 114 bear against one another. Regions of the joint 20 in which a relative movement of the two joint parts 112, 114 takes place are not coated. In this embodiment, it is possible in a particularly advantageous manner for a foil to be used as a coating, because it is the case in particular that large planar surfaces are present. It is optionally also possible for friction surfaces or contact surfaces of the two joint parts 112, 114 to be coated, in particular by way of a coating applied directly to the surfaces of the joint parts 112, 114.

In the embodiments illustrated in FIG. 9, a ready-from-the-mold joint is formed by virtue of one of the joint parts being injection-molded from a first material which shrinks to a greater extent than the surrounding shell of the other joint part. For example, the joint part 114 which is formed in the connecting element 18 may be injection-molded from POM, and the joint part 112 which is formed on the lower part 12 may be injection-molded from PA. This yields a corresponding joint when the workpiece cools. In embodiments of the invention, the joint may thus also be produced by way of a 2-component injection-molding process.

Even though FIGS. 7 to 9 each show merely a detail of the lower part 12 with a corresponding joint 20, it is the case, in embodiments of wiper blades, that a corresponding joint is likewise provided at other positions of the lower part 12 and at the positions of the upper part 10. In yet further embodiments that may be combined with other embodiments, it is possible for several of the joint variants described in this disclosure to be provided together for implementation on one wiper blade. For example, a joint according to one embodiment may be used in a first region of the longitudinal extent of the wiper blade, whereas a joint according to another embodiment is used in a second region of the longitudinal extent of the wiper blade.

In the embodiments described here, it is normally windshield wiper devices with rotary joints, for example in combination with relatively stiff connecting elements, that are described. In other embodiments, an upper part (10), a lower part (12) and the connecting elements (18) can be formed in one piece, wherein in particular, the upper part (10), the lower part (12) and the connecting elements are formed in one piece by way of a rubber structure with openings. Here, the connecting elements are elastically deformable.

FIG. 10 schematically shows a flow diagram for illustrating methods for producing a windshield wiper device, for example a windshield wiper device such as has been described in conjunction with FIGS. 7, 8A, 8B and 9. The method comprises (see step 1402) the production of an in particular elongate upper part, which is at least partially of flexible form, the production of an in particular elongate lower part, which is at least partially of flexible form, and the production of multiple connecting elements for connecting the upper part and the lower part. The method also comprises (see step 1404) the coating of at least one of the elements selected from the group comprising: upper part, lower part, connecting elements and joint with a coating.

The step 1402 may in this case comprise a single-step method, such as has been described for example above as a 2-component injection molding process. FIG. 10 serves for illustrating a further modification. The step 1402 of the method may in this case also comprise: the production of an upper part, which is at least partially of flexible form and has first joint parts, the production of a lower part, which is at least partially of flexible form and has first joint parts, and the production of multiple connecting elements for connecting the upper part and the lower part, wherein the connecting elements each have second joint parts. Furthermore, the step 1402 of the method may also comprise: the bending of upper part and/or lower part such that the openings of the hollow cylinders 112 in the region of the undercut are enlarged. It is thus possible for the connecting elements 18 to be inserted, whereupon the bending of the upper part and/or lower part is reduced such that the undercut engages around the cylinder 114. In this way, it is possible, from one end of the wiper blade to the opposite end of the wiper blade, for a multiplicity of connecting elements to be inserted. In particular, this may be performed both with the upper part and with the lower part in order to assemble the windshield wiper device. Said assembly may optionally be performed before and/or after the application of a coating.

In typical embodiments of the present invention that may be combined with other embodiments, the joint (see reference designation 20 in FIG. 6) or the joint 20 is a hinge. That is to say, two planes are rotatably connected to one another. In other words, a joint or a bearing with one degree of freedom is provided.

For example, in step 1402, a wiper blade of unipartite form is produced which has an upper part, which is at least partially of flexible form, a lower part, which is at least partially of flexible form, and multiple connecting elements, wherein the connecting elements are spaced apart from one another along a longitudinal extent of the windshield wiper device. This may be performed for example by way of an injection-molding process.

In the case of the joints as per FIGS. 8A and 8B, that is to say in the case of joints or hinges of two-part form, it is possible in particular to provide good creep behavior, for example a high level of creep resistance. The materials may be selected such that, in particular in the presence of high temperatures, no permanent deformation of the joints occurs. In this way, it is possible to provide improved longevity of the wiper blade 2. In particular, for two-part joints that are not produced using a 2-component injection-molding process, the cylinder or the sphere or the hollow cylinder or the hollow sphere, in each case with an undercut, may be manufactured from the same material. The function of the joint is thus impaired to a very minor extent by temperature fluctuations.

Even though the two-part design of the joint is possibly associated with slightly increased production costs (the joints have to be clipped), this may constitute an advantageous embodiment in particular for relatively complex fields of application or applications with relatively high demands. For example, higher demands exist in the case of front windshield wipers than in the case of rear windshield wipers.

With regard to usable materials, it is possible for a stiff or relatively stiff rib or a stiff connecting element, the lower part and the upper part to be formed for example from a plastic. This may for example be a fiber-reinforced plastic. A rubber profile of the wiper lip may, by contrast, be produced for example from a rubber-like material. The two different materials may be provided for example in a 2-component injection-molding process. In typical embodiments, a thermoplastic elastomer (TPE) may be used as rubber-like material. Typical materials may be selected from the group comprising: TPE (thermoplastic elastomer), TPE-S, TPE-O, TPE-U and TPE-A.

It is however also possible for the rubber profile of the wiper lip and/or for example a styling of the surface to be produced in the same injection-molding tool. By way of such a reduction of the injection-molding tools, the production costs can be reduced.

In the embodiments described here, it is possible for fin-ray wipers for vehicle windshields to be produced in a particularly inexpensive manner and/or for a multiplicity of different fields of use. Joints or rotary joints with suitable flexural rigidity are provided, which are suited to the usage conditions.

1. A windshield wiper device (2; 28, 30; 78) for a vehicle, comprising
an elongate upper part (10) which is at least partially of flexible form,
an elongate lower part (12) which is at least partially of flexible form,
multiple connecting elements (18) for connecting the upper part (10) and the lower part (12), wherein the connecting elements (18) are spaced apart from one another along a longitudinal extent (8) of the windshield wiper device (2; 28, 30; 78), and wherein the connecting elements (18) are fastened by way of joints (20; 122) to the lower part (12) and/or are elastically deformable, and
a coating (50) on at least one of the following: the upper part (10), the lower part (12), one of the connecting elements (18) and one of the joints (20; 122).

2. The windshield wiper device as claimed in claim 1, characterized in that the coating (50) is prevents formation of ice on a surface of the windshield wiper device.

3. The windshield wiper device as claimed in claim 1, characterized in that the coating (50) has, at least in sections, a nanostructured surface.

4. The windshield wiper device as claimed in claim 1, characterized in that the coating (50) has a surface energy of less than 30 mJ/m².

5. The windshield wiper device as claimed in claim 1, characterized in that the coating (50) has a coating thickness of 0.02 mm to 1.0 mm.

6. The windshield wiper device as claimed in claim 1, characterized in that the coating (50) is formed at least partially by a foil applied to a surface of the windshield wiper device.

7. The windshield wiper device as claimed in claim 1, wherein the joints (20; 122) have a flexural stiffness of 75 Nmm/rad or less.

8. The windshield wiper device as claimed in claim 1, wherein the joints are in the form of film hinges (122).

9. A method for producing a windshield wiper device, comprising:
producing a structure which comprises an upper part (10) which is at least partially of flexible form, a lower part (12) which is at least partially of flexible form, and multiple connecting elements (18) connecting the upper part (10) and the lower part (12), wherein the connecting elements (18) are spaced apart from one another along a longitudinal extent (8) of the windshield wiper device (2; 28, 74; 78; 90; 108), and wherein the connecting elements (18) are fastened by way of joints (20; 122) to the lower part (12) and/or are elastically deformable, and providing a coating (50) on at least one of the following: the upper part (10), the lower part (12), one of the connecting elements (18) and one of the joints (20; 122).

10. The method as claimed in claim 9, wherein the coating of the structure is performed by plasma treatment and/or comprises the adhesive bonding of a foil to the surface of the structure.

11. The method as claimed in claim 9, wherein the structure is a rubber structure.

12. The method as claimed in claim 9, wherein the coating (50) is provided on all of the upper part (10), the lower part (12), the connecting elements (18) and the joints (20; 122).

13. The windshield wiper device as claimed in claim 1, characterized in that the coating (50) has a surface energy of less than 25 mJ/m².

14. The windshield wiper device as claimed in claim 1, characterized in that the coating (50) has a surface energy of less than 20 mJ/m².

15. The windshield wiper device as claimed in claim 1, characterized in that the coating (50) is formed at least partially by a self-adhesive polyurethane foil applied to the surface of the windshield wiper device.

16. The windshield wiper device as claimed in claim 1, wherein the coating (50) is on all of the upper part (10), the lower part (12), the connecting elements (18) and the joints (20; 122).

17. A method for producing a windshield wiper device as claimed in claim 1, comprising:
producing a structure which comprises the upper part (10), the lower part (12), and the multiple connecting elements (18), and
providing the coating (50) on at least one of the following: the upper part (10), the lower part (12), one of the connecting elements (18) and one of the joints (20; 122).

18. The method as claimed in claim 17, wherein the structure is a rubber structure.

19. The method as claimed in claim 17, wherein the coating of the structure is performed by plasma treatment and/or comprises the adhesive bonding of a foil to the surface of the structure.

20. The method as claimed in claim 17, wherein the coating (50) is provided on all of the upper part (10), the lower part (12), the connecting elements (18) and the joints (20; 122).
